(19) United States
(12) Patent Application Publication
(10) Pub. No.: US 2015/0081452 A1
(43) Pub. Date: Mar. 19, 2015

(54) SYSTEM AND METHOD FOR INTERACTIVE MULTIMEDIA PLACEMENT

(71) Applicant: Kevin Edward ANTHONY, New York, NY (US)

(72) Inventor: Kevin Edward ANTHONY, New York, NY (US)

(21) Appl. No.: 14/258,705

(22) Filed: Apr. 22, 2014

Related U.S. Application Data
(60) Provisional application No. 61/877,413, filed on Sep. 13, 2013.

(51) Int. Cl. G06Q 30/02

(52) U.S. Cl. CPC G06Q 30/0271
USPC 705/14.67

(57) ABSTRACT

A system and method are provided that are configured to provide interactive multimedia placement. The system includes a user device configured to receive an input from a user through a user interface, and a display configured to receive a modified media file and a combinable media, and display the modified media file and the combinable media, wherein the input is processed by identifying a media file of the user and the combinable media, modifying the media file to produce the modified media file such that the modified media file is configured to be integrated with the combinable media, and transmitting the modified media file and the combinable media.

### CROSS-REFERENCE TO RELATED APPLICATIONS

The present application claims the benefit of U.S. Provisional Patent Application No. 61/877,413, filed in the U.S. Intellectual Property Office on Sep. 13, 2013. The content of the provisional application is hereby incorporated by reference in its entirety.

### BACKGROUND

1. Field

Apparatuses, systems, and methods consistent with exemplary embodiments relate to the field of advertising, and more particularly, apparatuses, systems and methods for interactive multimedia placement. Advancement in the field of advertising is achieved by providing the below-described system and method that is capable of modifying advertisements and other combinable media in real time to include user media such as videos or photos. Such modification may effectively splice a user into the advertisement, alternative media, or combinable media such that they appear to be part of the target media.

2. Description of the Related Art

Competition is considered to be a fundamental concept upon which a free market operates. Competition can be defined as two or more companies manufacturing a similar good or providing a similar service. A consumer has free will, and as such has the option to choose to purchase products from, or engage in service with, any company which is capable of providing that good or service. Thus, the companies compete for the business of the consumers. Generally, the more consumers a company has for a given product or service, the more successful the company may be. Thus, competition between companies may be fierce, and the competition may drive companies to continually search for new ways of decreasing prices or improving the quality of their goods or services such that they are more appealing to potential customers.

Additionally, a tactic that is commonly utilized by competing businesses is advertising. Advertising is a specialized form of communication which is designed to effectively and quickly disseminate information about a particular product or service to the public. As such, advertising is a central component of many modern businesses because a consumer cannot purchase a product or contract a service unless they have knowledge of this product or service. In addition to spreading information about products or services, advertisements also seek to elevate a given product or service above those of competitors in the minds of consumers. In this way, advertising is a tool that is often utilized in response to competition between companies which manufacture similar products or provide similar services.

There are many different types of advertising which exist in the modern world. Perhaps the most common forms of advertising include, but are not limited to, the following techniques; outdoor advertising, broadcast advertising, and internet advertising. Outdoor advertising is an old and widespread form of advertising and comprises virtually any form of sign, poster, flyer, sticker, or otherwise which is utilized for the purposes of spreading information about some product or service. Some of the most common forms of outdoor advertising include billboards and posters. Although this method of advertising is quite basic, it has been updated by technology in recent years. For example modern billboards often comprise a digital LED display in order to produce an image which can be altered at a moment's notice. This allows for semi-dynamic advertisements or possibly even video advertisements to be carried out using the outdoor advertising technique. Broadcast and internet advertising are two very similar methods of advertising in which advertisements are strategically placed in media or on websites which potential consumers visit. Broadcast advertising focuses on distribution of advertisements via radio and television broadcasts whereas internet advertising relies upon the global computing information exchange network known as the internet.

Advertisements have grown in their complexity and efficiency with companies developing new ways to motivate consumers to buy their product or service. For example, an important component of an effective advertisement is to appeal to the consumer's personal preferences and or general opinion on certain subjects. In this regard, advertisements have often attempted to become more personal to evoke an emotional response in consumers which can then drive or create and urge to buy a particular product or service.

Although demographic targeting and otherwise enhanced advertising techniques have improved the capabilities of advertisements in providing a more targeted and personal experience, marked room for improvement of advertising yield remains. Additionally, the increasing penetration or “creep” of advertising into an ever growing variety of locations including taxicab backseat monitors, gasoline pumps, and mobile device screens has contributed to ad desensitization or “ad fatigue” for potential consumers.

### SUMMARY

According to an aspect of an exemplary embodiment, there is provided a system configured to provide interactive multimedia placement, the system including a user device configured to receive an input from a user through a user interface, and a display configured to receive a modified media file and a combinable media, and display the modified media file and the combinable media, wherein the input is processed by identifying a media file of the user and the combinable media, modifying the media file to produce the modified media file such that the modified media file is configured to be integrated with the combinable media, and transmitting the modified media file and the combinable media.

The system may further include a server configured to receive the input from the user device, process the input by identifying the media file and the combinable media, modify the media file such that a modified media file is configured to be integrated with the combinable media, and transmit the modified media file and the combinable media to the display.

The user device may be configured to process the input by identifying the media file and the combinable media, modify the media file such that a modified media file is configured to be integrated with the combinable media, and transmit the modified media file and the combinable media.

The display may be configured to receive the input, process the input by identifying the media file and the combinable media, modify the media file such that a modified media file is configured to be integrated with the combinable media, and display the modified media file and the combinable media.

The system may further include a queue that is configured to manage an order in which a plurality of user media files is integrated with the combinable media and an amount of time for which a specific one of the plurality of user media files remains integrated with the combinable media.

The processing of the input may be done in real time and is based on at least one from among the user's input, a user friend's input, and an advertiser's input.

The display may display the modified media file and the combinable media based on at least one from among a proximity of the user device to the display, an amount paid by a user through the user device, a quality value of a task completed by the user through the user device, a count value of a total number of a plurality of tasks completed by the user through the user device, a priority of the user, and a rank of the modified media file and the combinable media determined by other users.

The display may be part of at least one from a group of Out of Home (OOH) advertising devices including a billboard, a transit vehicle, a street furniture, an arena, a fuel station, a dining establishment, a social establishment, a retail establishment, a health club, an educational campus, a shopping center, a public space, a computer screen, a smart phone display, a tablet display, an audience display, a cinema, a television, a concert, and wherein the combinable media may be an advertisement that is at least one from a group including a digital image, a video, an audio file, an online advertisement, a TV broadcast commercial, and a mobile application advertisement.

According to an aspect of another exemplary embodiment, there is provided a user device configured to provide interactive multimedia placement, the user device including a display configured to display a user interface and receive a request from a user, a controller configured to process the request by identifying a media file and a combinable media, and modify the media file such that a modified media file is configured to be integrated with the combinable media, and a transmitter configured to transmit the modified media file and the combinable media.

The user device may further include a queue that is configured to manage an order in which a plurality of user media files is integrated with the combinable media and an amount of time for which a specific one of the plurality of user media files remains integrated with the combinable media.

The processing of the input may be done in real time and is based on at least one from among the user's input, a user friend's input, and an advertiser's input.

Transmitting the modified media file and the combinable media may be based on at least one of a proximity of the user device to the display, an amount paid by a user through the user device, a quality value of a task completed by the user through the user device, a count value of a total number of a plurality of tasks completed by the user through the user device, a priority of the user, and a rank of the modified media file and the combinable media determined by other users.

According to an aspect of another exemplary embodiment, there is provided a display device configured to display a media file and a combinable media, the display device including a receiver configured to receive a request from a user, a controller configured to process the request by identifying a media file and the combinable media, modify the media file such that a modified media file is configured to be integrated with the combinable media, and a display configured to display the modified media file and the combinable media.

The display device may further include a queue that is configured to manage an order in which a plurality of user media files is integrated with the combinable media and an amount of time for which the plurality of user media remains integrated with the combinable media.

The processing of the input may be done in real time and is based on at least one from among the user's input, a user friend's input, and an advertiser's input.

The display device may display the modified media file and the combinable media based on at least one from among a proximity of a user device to the display, an amount paid by a user through the user device, a quality value of a task completed by the user through the user device, a count value of a total number of a plurality of tasks completed by the user through the user device, a priority of the user, and a rank of the modified media file and the combinable media determined by other users.

According to an aspect of another exemplary embodiment, there is provided a method for providing interactive multimedia placement, the method including receiving, from a user device, a media file, modifying the media file such that a modified media file is configured to be integrated into a combinable media, and displaying, on a media display, the modified media file and the combinable media.

The method may further include integrating the modified media file into the combinable media.

The modifying and displaying may be performed in real time and is based on at least one from among the user's input, a user friend's input, and an advertiser's input.

The displaying the modified media file and the combinable media may be based on at least one of a proximity of the user device to the media display, an amount paid by a user through the user device, a quality value of a task completed by the user through the user device, a count value of a total number of a plurality of tasks completed by the user through the user device, a priority of the user, and a rank of the modified media file and the combinable media determined by other users.

The method may further include receiving, from the user device, a request for the media file, wherein modifying the media file further includes splicing the modified media file into the combinable media in real time, and wherein displaying the modified media file and the combinable media further includes displaying, on the media display, the combinable media with the spliced in modified media file.

The displaying may be based on at least one from among a proximity of the user device to the display, an amount paid by a user through the user device, a quality value of a task completed by the user through the user device, a count value of a total number of a plurality of tasks completed by the user through the user device, a priority of the user, and a rank of the media file and the combinable media determined by other users.

Other aspects and advantages of the invention will be apparent from the following description and the appended claims.

### BRIEF DESCRIPTION OF DRAWINGS

FIG. 1 is a basic system map according to one or more exemplary embodiments of the present disclosure.

FIG. 2 is a system map including a server according to one or more exemplary embodiments of the present disclosure.

FIG. 3 is a system map including a plurality of media/advertisement display apparatuses according to one or more exemplary embodiments of the present disclosure.

FIG. 4 is a system map including a plurality of user devices according to one or more exemplary embodiments of the present disclosure.

FIG. 5 is a system map including a user and a user interface according to one or more exemplary embodiments of the present disclosure.

FIG. 6 is a flowchart displaying an overall method according to one or more exemplary embodiments of the present disclosure.

FIG. 7 is a flowchart depicting a method by which a queue organizes new requests into three basic priority groups according to one or more exemplary embodiments of the present disclosure.

FIG. 8 is a flowchart depicting how user media flows through a system according to one or more exemplary embodiments of the present disclosure.

FIG. 9 is a flowchart depicting how users may bid to have their media incorporated into an advertisement at a specific time and for a specific amount of time according to one or more exemplary embodiments of the present disclosure.

FIG. 10 is a drawing depicting how an advertisement may appear with part of an ad unalterable by a consumer, and part of it reserved for the insertion of user media according to one or more exemplary embodiments of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. The scope is defined not by the detailed description but by the appended claims. Like numerals denote like elements throughout.

Although the terms used herein are generic terms which are currently widely used and are selected by taking into consideration functions thereof, the meanings of the terms may vary according to the intentions of persons skilled in the art, legal precedents, or the emergence of new technologies. Furthermore, some specific terms may be randomly selected by the applicant, in which case the meanings of the terms may be specifically defined in the description of the exemplary embodiment. Thus, the terms should be defined not by simple appellations thereof but based on the meanings thereof and the context of the description of the exemplary embodiment. As used herein, expressions such as “at least one of,” when preceding a list of elements, modify the entire list of elements and do not modify the individual elements of the list.

It will be understood that when the terms “includes,” “comprises,” “including,” and/or “comprising,” when used in this specification, specify the presence of stated elements and/or components, but do not preclude the presence or addition of one or more elements and/or components thereof. As used herein, the term “module” refers to a unit that can perform at least one function or operation and may be implemented utilizing any form of hardware, software, or a combination thereof.

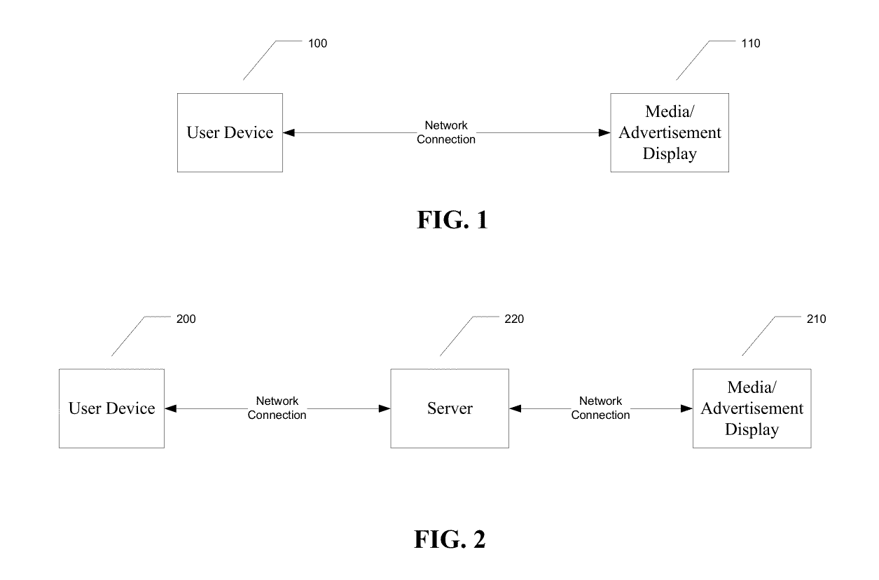

One or more exemplary embodiments may enable much greater personalization and engagement of advertisements, alternative media, and combinable media such that they can be much more appealing to consumers. One or more exemplary embodiments may provide a system and method which allows consumer media such as a picture or a video clip to be spliced into an existing advertisement or alternative media in real time. For example, as shown in FIG. 1, a user may utilize their user device 100 to transmit over a network connection some media data to a media/advertisement display 110.

Further, one or more exemplary embodiments may allow for the creation of a queue which manages the order in which user media is integrated and the amount of time for which the media remains integrated before being switched to that of another user. For example, as shown in FIG. 2, a user may use a user device 200 to transmit their media content over a network connection to a server 220 which may manage the queue and process the media content integration with the combinable media/advertisement selected by a user. Then the server 220 may transmit over a network connection the integrated media and advertisement to a media/advertisement display 210. Thus, one or more exemplary embodiments may provide a new way of advertising which drastically improves the personal aspect of advertising by way of allowing consumers to effectively insert themselves or associates into an advertisement and potentially become highly coveted brand advocates for advertisers. By allowing the consumer to effectively “co-create” the media he/she consumes, a more personal bond may be established with a brand and a higher level of consumer engagement may be attained.

One or more exemplary embodiments may be configured to provide a system and method for interactive multimedia placement which is specifically designed to allow real time insertion of user media into preexisting advertisements or alternative media. This allows consumers to effectively place themselves into a combinable media/advertisement, thereby professing their support for a given product or service, as well as being able to further associate themselves with a company beyond just being a simple customer. One or more exemplary embodiments may comprise both a system and a method. The system of the one or more exemplary embodiments may contain all the physical and conceptual components to carry out the method, and therefore function properly. The system may include, for example, a user device, a user interface, a server, and a media/advertisement.

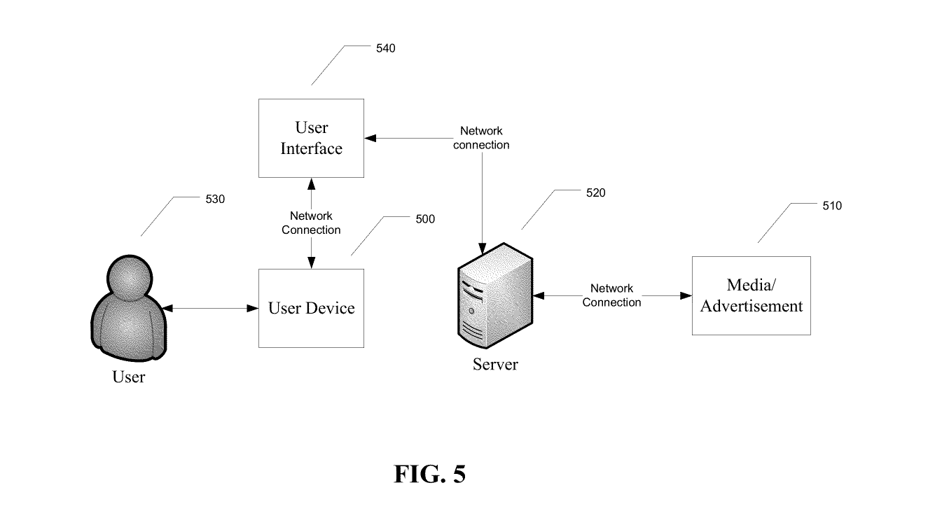

According to an exemplary embodiment, a user device represents the physical computing device which a user utilizes in order to access functions offered. Particularly, a user interface may facilitate interaction between the user and the system. As shown in FIG. 5, a user 530 may use a user device 500 to access a user interface 540 through a network connection. Alternatively the user interface may be provided on or at the user device. Further the user 530, using the user interface 540, may communicate with a server 520 and ultimately with a combinable media/advertisement 510. In the modern world there is a large focus upon compatibility and interoperability of programs and interfaces, and the one or more exemplary embodiments are no exception. The user device may therefore be virtually any computing device which is capable of accessing the internet via an internet browser program or specialized software application. Thus, the user device may be any one of a number of modern computing devices which includes but is not limited to personal computers, tablet computers, and smart phone devices.

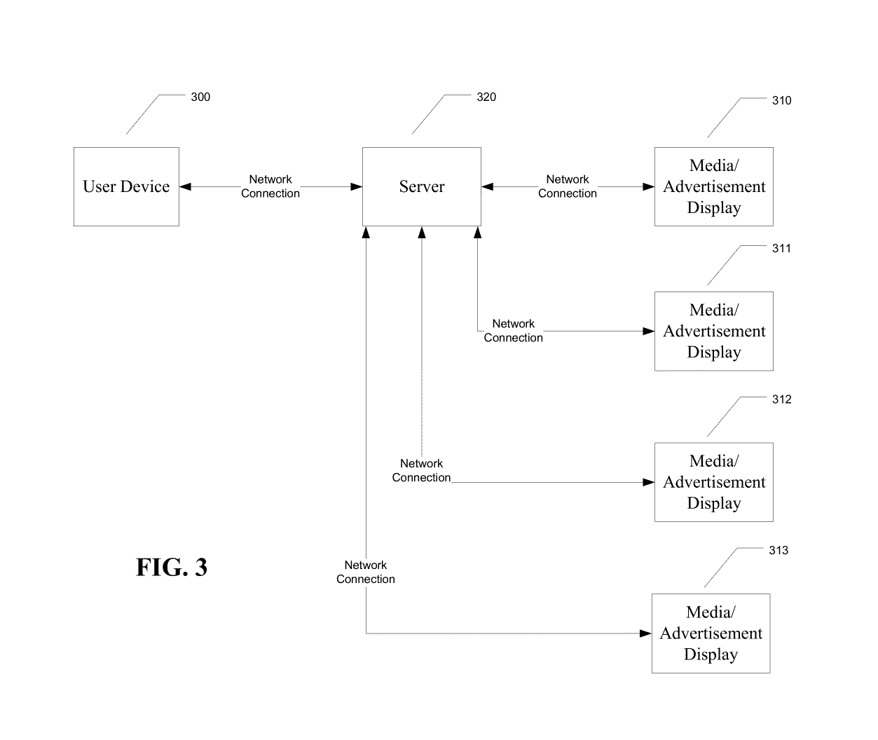

As shown in FIG. 3, according to an exemplary embodiment, a user may use a user device 300 to transmit media data which may or may not already be integrated with an advertisement, to a server 320. The server may operate a queue for the user content and may operate a queue to determine when and to which media/advertisement display(s) the user content is sent to. Further the server 320 may also process and integrate the media content from the user into one or a plurality of advertisements. Then the server 320 may transmit the one or more integrated media and advertisement to one, a few, or all of the media/advertisement displays 310-313. For example the user may select an image of themselves they would like integrated and sent to all small displays within their proximity while excluding any large displays. The server 320 may then determine which of the displays meet the user's criteria. For example, it is possible that the displays 310, 311, and 312 are all small while the display 313 is a large billboard in the area. The server could then send the user media to the three smaller screens 310, 311, and 312. Alternatively, if the large billboard meets the user's criteria, the user media could be sent to the large billboard.

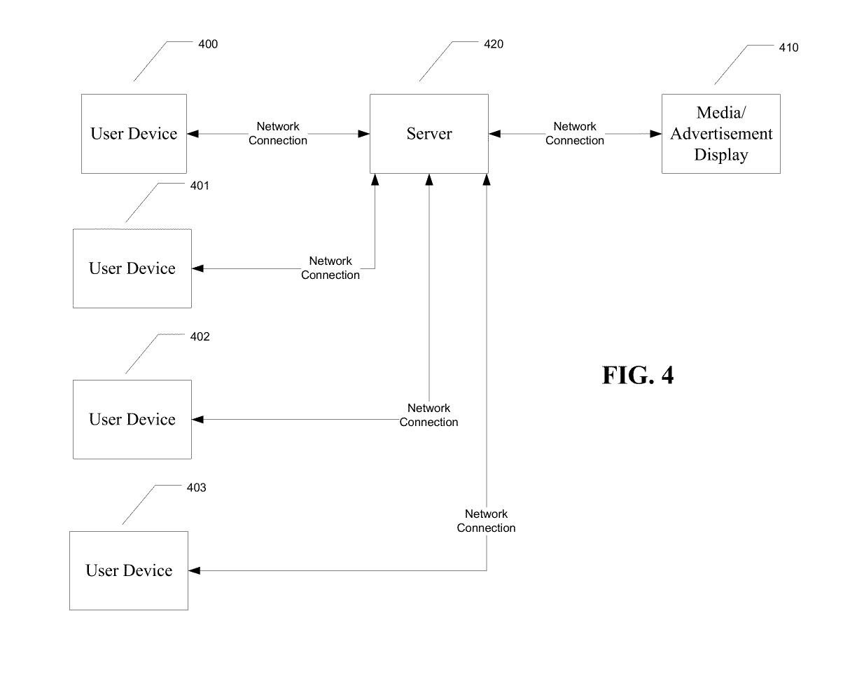

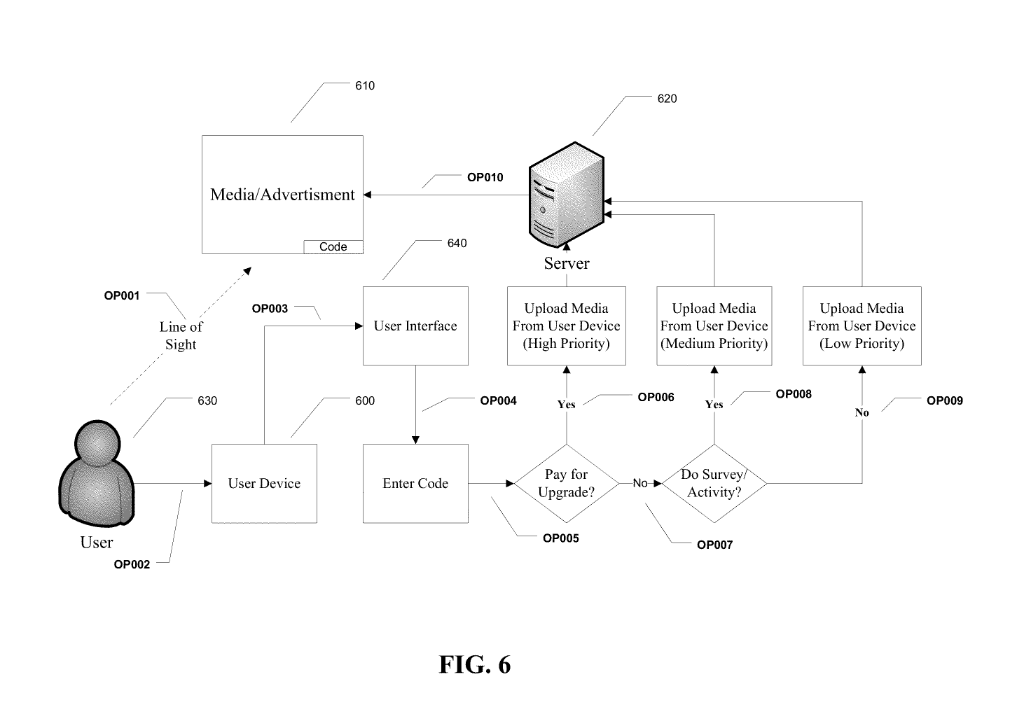

FIG. 4 is a system map including a plurality of user devices according to one or more exemplary embodiments of the present disclosure. Specifically, FIG. 4 shows a plurality of user devices 400-403, which may be operated by different users or a single user, which are connected to the server 420. The user devices 400-403 may transmit media data to the server 420 and the server 420 may take the media data from the user devices 400-403 and organize the media data in a queue. The placement in the queue may be determined based on a number of different factors as described later with reference to, for example, FIGS. 6, 7, and 9.

According to an exemplary embodiment, the user interface is responsible for allowing the user to interact and carry out the operations of the method. The user interface may comprise a plurality of windows which allow the user to navigate throughout the user interface and to access its many functions. The user interface may also allow for the creation of a user account which identifies the user based upon a unique login ID and password. This login ID and password are utilized by the system to verify the identity of any given user upon activation of the user interface. The user account is also responsible for keeping track of certain information which is accumulated by the user through operation of the method.

According to one or more exemplary embodiments, there may be provided an application programming interface (API) provided to allow an advertiser/media sponsor to program a graphical user interface to be used as a user interface for receiving a user input for advertisement/media integration. Specifically, according to an exemplary embodiment, customer-modified media, may be centrally stored on at least one server whereby an open API permits the customer-modifiable media and associated API to function as an ad/media exchange in which third party advertisers/sponsors may directly source “co-creative” media for placement across multiple medium formats including but not limited to digital billboards, networked user devices, webpages including search engines, social networks, news, blogs and within user applications such as game and utility applications, television, cinema, and print publications such as magazines that can feature media placements featuring “real” readers.

Alternatively, according to another exemplary embodiment, a customer or brand advertiser may elect to utilize the API to source co-created media for propagation through alternative, preexisting ad platforms and/or ad exchanges.

For each of the above disclosed embodiments the advertiser may source either (a): the entire visual medium which includes customer and advertiser components such as still picture or video, optionally with or without audio or (b): only the customer component itself for the purpose of being able to present multiplicative contexts with alternative brands. For example, customer Kate co-creates a picture by inserting a graphical overlay of her own face onto a figure dunking a Brand Z cookie in milk over LeBron James (her favorite player). This entire graphic may be sourced just as Kate “co-created” with advertiser originally. However, independently, at home a week later, when customer Tom (Kate's best friend and social network connection) searches “Magic Johnson” on a search engine page, his screen is instantly populated with a display (on the sidebar or elsewhere) of his best friend Kate (because of the social network connection) dunking a basketball (instead of cookie because of the search-specific athletic context) on Magic Johnson (instead of LeBron James because of the specific search term) with Kate's representative figure augmented to feature Adidas footwear (because Tom “follows” the Adidas brand social page) and a customized ad tagline which states: “Don't let Kate [viewer's friend] score all the points. Upgrade your Adidas at a discount today!”

This embodiment (b) described above may have three embodiment permutations of its own. One embodiment (b1) may include viewer driven placements, as exemplified above whereby brand and subject/person offerings are customized based on the media viewer's social network and/or search-specific context. Another embodiment (b2) may include subject driven placements. Here, the viewer is presented with a media featuring his/her best friend (or other social connection), for example, in proximity to an event (a birthday for example) and the friend's media representation is pictured with the products and/or brands they have explicitly “liked”/“followed” or otherwise displayed preference for in a social network. Yet another embodiment (b3) may include marketer driven placements, whereby the marketer(s) with the highest willingness to pay/bid and/or provide an (optionally) incentivized offering (for example, an offer of “20% off storewide by clicking here now”) that graphically depicts retail accessories that retailer wishes to present to viewer(s). For example, tomorrow is the birthday of the viewer's mother and the branded florist, jeweler, handbag company, etc. with the highest willingness to pay (bid) and/or present an incentivized purchase offer will get their product(s) placed in the customized media featuring viewer's mother outfitted with the gifts that she may enjoy, which may all be presented adjacent to viewer search engine results (or other user device screen space) in lieu of customary text ads utilized today. These embodiments may be achieved by access/integration with the social graph of a user's social network via means those skilled in the art are familiar with including social network API access. To accommodate varying personal privacy preferences among users, this functionality may be implemented to numerous degrees of specificity. For example, the advertiser may only be informed that an advertisement is being presented to “user X” with income Y who is the daughter of “user Z” who is K years of age with a birthday in R days, in contrast to being informed that an ad is being presented to Jane D. Smith of New York, daughter of Mary P. Smith of Connecticut.

According to an exemplary embodiment, the server may be responsible for storing all information regarding all user accounts of the users who utilize the system or method. In addition to storing the user account information, the server may also be responsible for accepting and organizing user media into a queue. User media is any digital file which is input into the system that is capable of being integrated into an advertisement or alternative media. User media may include but is not limited to pictures, video clips, and audio clips. The user media may be stored on the server while it is awaiting integration into a particular media/advertisement where it may also reside. The user media is organized into a queue based upon several different factors such as, but not limited to, a time stamp, a bid amount, a user ranking value, and a location proximity. The server is connected to the internet via a network connection, through which it receives all user media. The server is also responsible for integrating user media into the media/advertisement in real time. This is also accomplished via a network connection.

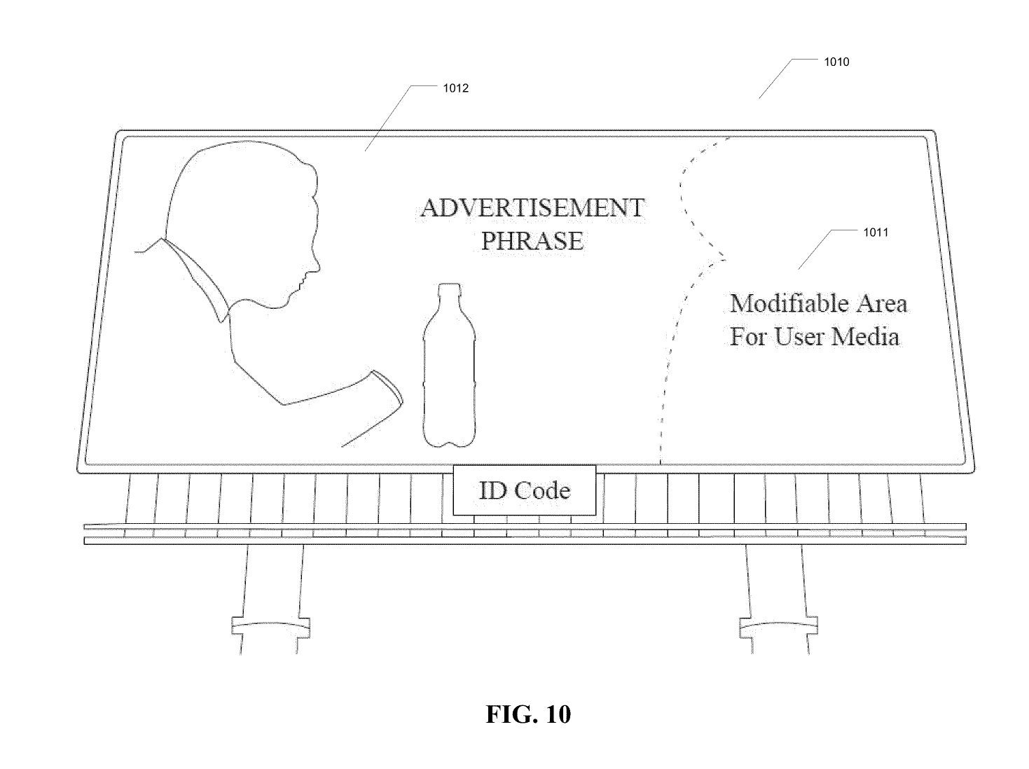

According to an exemplary embodiment, another component of the system is the combinable media/advertisement itself. The combinable media/advertisement represents any media item or commercial advertisement which is designed to be used in conjunction with the system. The media/advertisement is largely no different from any other advertisement, with the exception of the fact that the media/advertisement is specifically designed to have user media spliced into it. Thus, the media/advertisement possesses at least one section which is intended and formatted to receive the user media, as can be seen in FIG. 10. Part of the media/advertisement is predefined by the company which the media/advertisement represents while another part of it (which may be prepopulated by advertiser/media sponsor) is modifiable by the one or more exemplary embodiments on behalf of consumers. When the media/advertisement is modified by the one or more exemplary embodiments, the user media is spliced in, creating a finished media/advertisement which is fully integrated with the user media. This creates the illusion that the user media was integrated into the advertisement from the start, thereby effectively featuring the user within the advertisement by way of the user media integration. There are many different types of media/advertisements which may be suitable to be used in one or more exemplary embodiments. Examples of types of media/advertisements which may be used in one or more exemplary embodiments include but are not limited to radio ads (and other audio only mediums), TV ads and programming content, internet ads, and “out of home” (OOH) media including digital billboards. The OOH may consist of a billboard, a transit vehicle, a street furniture, an arena fixture (including but not limited to large screen displays and ad mediums bordering stage/court/rink areas), a fuel station, a dining establishment, a social establishment, a retail establishment, a health club, an educational campus, a shopping center, a public space, a computer screen, a smart phone display, a tablet display, an audience display, a cinema, a television, a concert. Further, the combinable media may be an advertisement that is at least one from a group consisting of, a digital image, a video, an audio file, an online advertisement, a TV broadcast commercial, and a mobile application advertisement

According to one or more exemplary embodiments, the splicing may be done in many different ways. As shown in FIG. 10, the splicing may be done by providing an area that requires a specific user element, such as a picture of a person from a designated profile/angle that corresponds to the specific advertisement. Another example may include a user which provides an entire backdrop image and can also modifiably select the product and place it within the environment the user has provided through the user interface. Another example may include a video portion where a user can input their video that is integrated into a portion of the advertisement. Another example may include splicing multiple areas within a single advertisement with the user media. Further, another example may include a user providing user media that includes user specific information such as a user location, a user name, and user generated text, etc. which can be used to fill in certain modifiable areas to personalize the media/advertisement in addition to the specific user image provided as well. A specific example of this would be if a user provided an image of themselves to have spliced into an media/advertisement as well as providing a personal testament of the product and their hometown. The advertisement would then fill in the user modifiable areas that may include showing the user, showing a quotation bubble that contains the user text, as well as modifying the background image to their hometown. A person of ordinary skill in the art can envision a plurality of different combinations using user media spliced into advertisements/combinable media.

The method as described represents an exemplary embodiment, and it is accepted that alternative configurations of method operations may exist which perform certain functions in a different order but ultimately accomplish the same final goal. The method may include the following operations.

As shown in FIG. 6, a user 630 may use a user device 600 and a user interface 640 to enter a code which may determine that the user 630 is able to inject their media data onto media/advertisement 610, along with the associated advertisement which may be done through a controlling server 620. Specifically, in operation one (OP001), the user views the media/advertisement. The media/advertisement contains at least some indication that it is linked and can accept user media for integration. The advertisement also includes an identification code which identifies that particular advertisement to the system. The user will utilize this ID code if they wish to have their user media integrated into that particular advertisement. A general overview of the method can be seen in FIG. 6, and this first operation OP001 is represented by the user's line of sight to the media/advertisement.

In operation two (OP002), the user accesses the user device. As mentioned above, the user device may be any one of a number of different common modern computing devices. These modern computing devices which may be used as the user device include but are not limited to personal computers, tablet computers, and smart phones. In operation three (OP003), the user accesses the user interface, which as described above, allows the user to interact in a number of different ways. The user may also login to their specific user account in this operation, thereby identifying themselves to the system and potentially gaining access to certain information and functions pertaining to their specific user account.

In operation four (OP004), the system receives an ID code entry from the user. The ID code relates to the specific advertisement that the user wishes to personalize. ID code entry is affected by the user through the user interface. The ID code is important in order to identify exactly what advertisement the user wishes to have the user media incorporated into. It is also contemplated the user may browse through a list of media/advertisements via the user interface (optionally utilizing GPS proximity) where the user is provided with information about where the media/advertisement is located, what type of media/advertisement it is, when the media/advertisement will be active, as well as a preview of the media/advertisement. The user is also able to obtain the ID code for any media/advertisement this way, thus the user is not limited to having the user media incorporated only with media/advertisements they see personally, but also with any media/advertisement integrated into the media/advertisement network.

In operation five (OP005), the system receives a user decision on whether or not the user wishes to select and pay for an optional upgrade. The upgrade has certain advantages such as increased priority in the display queue, extended display duration of the user media integrated into the advertisement/alternative media, as well as additional modifiable areas or modifying options including the ability for multiple users to modify the same media/advertisement together, simultaneously.

In operation six (OP006), if the user has decided to pay for the upgrade, the user uploads the user media into the queue via the user device. Since the user has paid for an upgrade, the user media is placed within the queue under the classification of high priority. User media which is input as high priority may be integrated into the advertisement/alternative media sooner, and it may be integrated for a longer display duration, thus providing some incentive for the user to actually pay for the upgrade.

In operation seven (OP007), if the user has decided not to pay for the upgrade, the system queries the user about the possibility of the user performing an optional survey or other activity designed to gather or impress user-specific information feedback. This information can be highly useful to a company, and as such the engagement can be viewed as a value-added gesture, allowing the user to gain some level of prioritization within the queue without actual monetary payment for an upgrade. In another operation, if the consumer has not purchased an upgrade, the system receives a user decision on whether or not the user wishes to review a targeted promotion or advertisement.

In operation eight (OP008), if the user has decided to participate in a survey or activity, the user uploads the user media into the server. The user media is placed into the queue as a medium priority. Medium priority is lower than high priority, but it is not the lowest priority, therefore the user has some incentive to perform the survey or the activity in order to have the user media integrated with the advertisement sooner and/or for longer display duration.

In operation nine (OP009), if the user has decided not to participate in the survey or activity, then the user media is uploaded to the server and entered into the queue as low priority. The low priority is lower than both medium and high priority, and therefore it is generally integrated into the advertisement last, possibly for the shortest duration, and in some cases only if there is time remaining after all high and medium priority entries have been integrated for their allotted time.

In another operation, the consumer may elect to become a marketer and brand advocate for the advertiser by promoting customized ads to their associates via popular social media networks. This is highly advantageous for the advertiser/content sponsor as it both transforms and multiplies the effective reach of the original advertisements/alternative media to new mediums and potential customers, all at the hand of incremental effort from the brand advocate customer instead of the brand itself.

In another operation, the media which is waiting in the queue to be integrated is viewable by all other users (and/or optionally a moderator designated by the media sponsor). Any user media which is deemed inappropriate by a specified amount of reviewers will be withheld temporarily pending a review. If the review reveals that the user media is in fact inappropriate, then all the users who flagged it as such are rewarded. The reward comprises a sum of credits which can be accumulated over time by the user. Eventually the user may accumulate enough credits to earn free high priority upgrade for the next ad placement of the user's choice. Thus there is incentive for users to accurately flag inappropriate content, thereby creating a self-policing community. As a result, it may also be necessary to penalize users some number of credits if the user media proves to not be inappropriate after all. This ensures that there is negative incentive to creating false positives for the sole reason of obtaining credits. User media reviewed by a select number of people without being flagged as inappropriate may be deemed “prescreened,” and as such, may subsequently be re-submitted and incorporated into any number of future interactive media placements without delay and possibly instantaneously. Additionally, during user media review, persons may opt to categorize user attributes including but not limited to facial expressions (illustrative examples include: happy, serious, scary, sad, angry) age (illustrative examples including: youth, adult, senior) and sex (male/female) to facilitate automated placement in the appropriate media context (to prevent a “happy” face from being placed in a “scary” horror-themed media or prevent a teenager from promoting an arthritis treatment media for example).

In operation ten (OP010), the user media is integrated into the media/advertisement. The user media is integrated in a specific order and stays integrated for a set amount of time. Both of these parameters may be governed by the priority of the user media and when it was inserted into the queue. Thus, the one or more exemplary embodiments are able to integrate user media into the advertisement in a manner which is fair and economical.

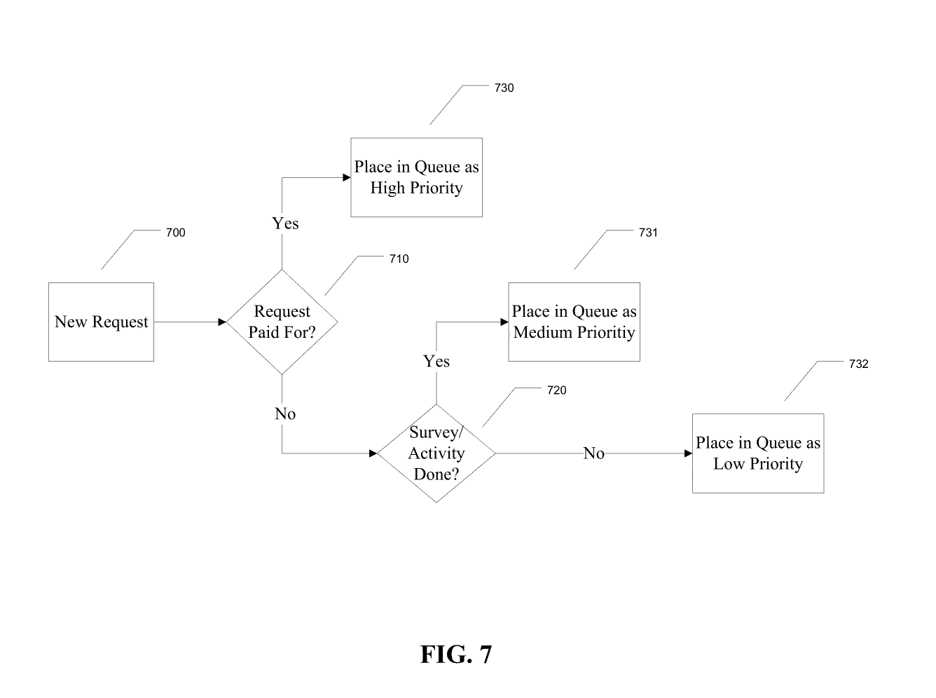

FIG. 7 is a flowchart depicting a method by which the queue organizes new requests into three basic priority groups according to one or more exemplary embodiments of the present disclosure. As shown in FIG. 7, a new request 700 may be provided by a user. This request may include an explicit user request asking to enter user media or a combined request that contains a plurality of user media as well as the user information and possibly payment information. Then a check 710 may be made by the system to see if the user paid for the request. The payment may be made using points earned by the user that are proprietary to the media splicing user interface or application, a credit or debit card, a PayPal account, cryptocurrency, or some other form of a value for access/service transaction. Further a check 720 may be made to see if the user participated in an activity that provides the user with additional priority if completed. This activity may include taking a survey, viewing a promotional advertisement, or some other activity. Then according to whether the user paid and/or participated in the activity, the user media and request will be placed in a corresponding queue 730-732 with a certain priority level.

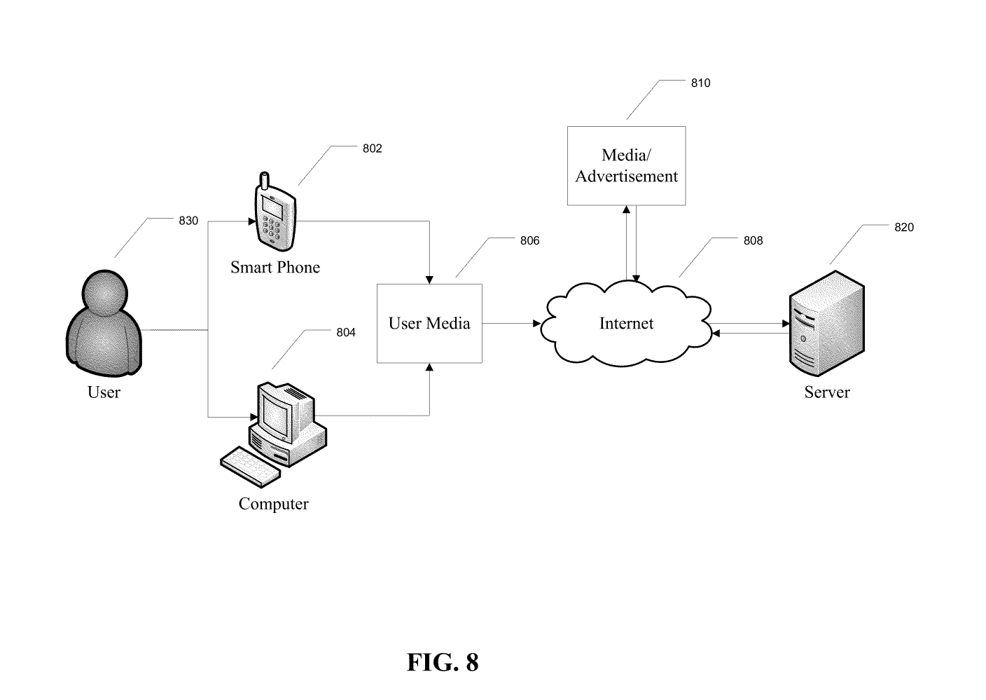

FIG. 8 is a flowchart depicting how user media flows through a system according to one or more exemplary embodiments of the present disclosure. As shown in FIG. 8 a user 830 may use one or both of a smart phone 802 and a computer 804 to access and interact with the user media 806. Further, the user media may be transmitted through the internet 808 to a server 820 for storage, processing, or further transmitting to other users, displays, social networks, or back to the original user. Also, the user media 806 may be transmitted straight from the user 830 and smart phone 802 or computer 804, through the internet 808, to a media/advertisement 810 which may be in the form of a billboard, online advertisement, or other such element.

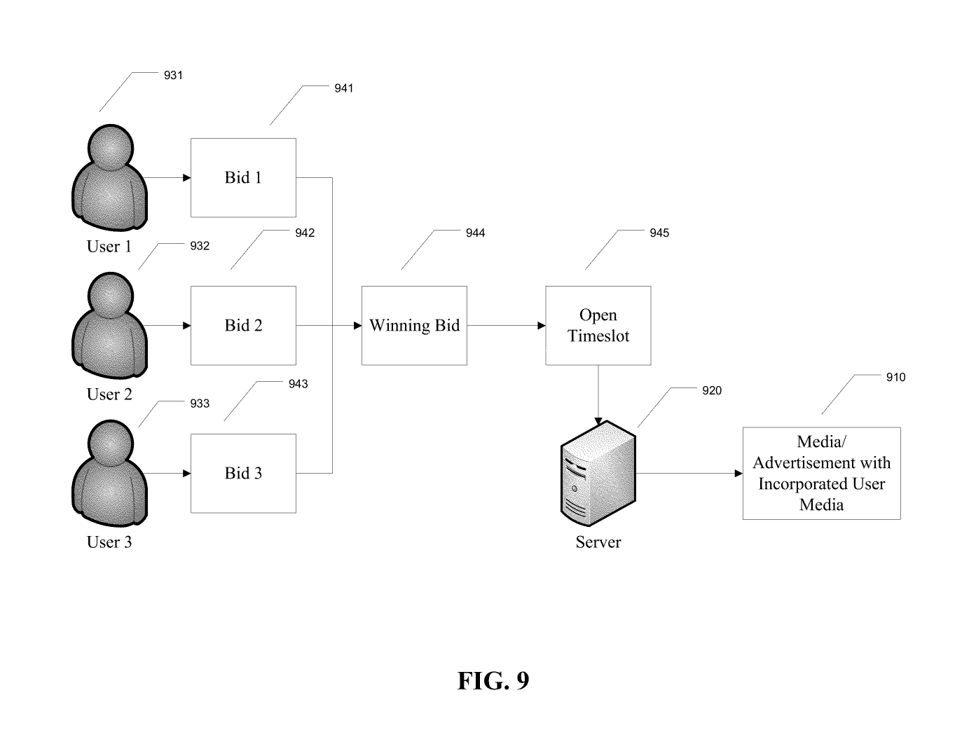

As shown in FIG. 9, according to one or more exemplary embodiments, the method may include additional operations occurring just after operation five (OP005) as shown in FIG. 6. These additional operations allow the users 931-933 to bid against each other for a specific timeslot during which their media is integrated into the advertisement. This can be useful for sporting or other events where the advertisements are viewed by thousands of people in one place, thereby providing increased incentive for having the user media integrated into the advertisement. The alternative additional operations include the following. In an operation 941-943, the corresponding user places a bid for a specific timeslot on a specific advertisement. This occurs for a plurality of users over some time period, thus offering many users a fair chance at purchasing the timeslot. In another operation, the system selects the winning bid 944 based upon monetary amount. In yet another operation, the selected winner uploads the user media to a server 920 that they wish to occupy the timeslot 945 they have just successfully purchased. This alternative method skips all other operations through operation ten, where it runs parallel with the preferred embodiment as described above. A flow chart depicting this alternative method can be seen in FIG. 9 where the user who wins the bid 944 for a timeslot 945 has his/her media displayed on the media/advertisement 910.

FIG. 10 is a drawing depicting how an advertisement may appear with part of an ad unalterable by a consumer, and part of it reserved for the insertion of user media according to one or more exemplary embodiments of the present disclosure. Specifically, FIG. 10 shows a billboard 1010 which may contain at least two areas. The first area may be an area that is set by the advertiser 1012. The second area may be a modifiable area for user media 1011. Alternatively, according to another exemplary embodiment, a modifiable media provided by an advertiser, which is combined with a media file from a user, may be completely replaced with the media file when displayed. For example, the user provided content may be all that is displayed on the billboard wherein the only portions of the modifiable media that is integrated with the user media is data or information about where and how to display content on the billboard such as image size, a specific device address, and file format thereby providing access to the billboard on which only the media file from the user is then displayed.

According to another exemplary embodiment, the user provided media data may be integrated into other combinable media outlets such as social media integration, TV show integration, etc. For example, a poster of a “WANTED” persons may be featured on a digital billboard, within a TV show as a screen shot on a display area found within the show, or within a similar cinema screen shot. During cinema previews user may enter a screen code into a mobile application and review predetermined segments where viewers may modify content. Viewer may then opt to insert their own, or a friend's, facial profile next to the film's featured hero/villain when that sequence occurs. Similarly for TV, an alternative embodiment may permit the user to impact their own screen only, or alternatively the entire broadcast. Additionally the market may select a “winner” to feature across multiple mediums including billboard, TV ad, and cinema production. Select users may opt to share their geo-location information for more specialized marketing. Another specific example would be, for example, on a user's wedding anniversary as they commute to work, standing on the train platform, proximity enabled targeting allows user's spouse to present a customized billboard message/endorsement displaying, for example, “To my Love . . . [wedding photo].” As the user continues to ride the train, the billboard in proximity/view can display an additional distinct message as the user passes them, and then switch to a different image as the user leaves the proximity of the display.
One or more of the above disclosed embodiments, may provide an entirely new advertising paradigm whereby for the first time consumers can co-create and co-influence their media experience in real time. Additionally, one or more exemplary embodiments may also allow consumers to pay with time or money to become brand advocates and perpetuate highly coveted forms of advertising such as word of mouth and personal endorsement to personal connections). Further, one or more exemplary embodiments may provide an entirely new social media paradigm and monetization strategy as compared to the existing social media offerings that crudely interrupt the user social feed experience intermittently with advertisements/promotions. This is at least in part because one or more of the exemplary embodiments may bring brand advocates and their brands closer together according to the peoples' choice. Additionally, instead of passively “following” favorite brands, in a unique way users may actually share the limelight with their favorite brands and celebrities together, effectively bridging the gap between fan and star and by allowing consumers/fans to integrate themselves into the media content and realistically co-create the media they consume, permitting the ultimate personalization experience. While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

Although the present invention has been explained in relation to its preferred embodiments, it is to be understood that many other possible modifications and variations can be made without departing from the spirit and scope of the invention as herein described including application of the aforementioned interactive media placement directly to content in cinema, television programming and video game mediums.

1. A system configured to provide interactive multimedia placement, the system comprising:
a user device configured to receive an input from a user through a user interface; and
a display configured to receive a modified media file and a combinable media, and display the modified media file and the combinable media,
wherein the input is processed by identifying a media file of the user and the combinable media, modifying the media file to produce the modified media file such that the modified media file is configured to be integrated with the combinable media, and transmitting the modified media file and the combinable media,
wherein the display displays the modified media file and the combinable media based on at least one from among a proximity of the user device to the display, an amount paid by a user through the user device, a quality value of a task completed by the user through the user device, a count value of a total number of a plurality of tasks completed by the user through the user device, a priority of the user, and a rank of the modified media file and the combinable media determined by other users.

2. The system of claim 1, further comprising:
a server configured to receive the input from the user device, process the input by identifying the media file and the combinable media, modify the media file such that a modified media file is configured to be integrated with the combinable media, and transmit the modified media file and the combinable media to the display.

3. The system of claim 1, wherein the user device is configured to process the input by identifying the media file and the combinable media, modify the media file such that a modified media file is configured to be integrated with the combinable media, and transmit the modified media file and the combinable media.

4. The system of claim 1, wherein the display is configured to receive the input, process the input by identifying the media file and the combinable media, modify the media file such that a modified media file is configured to be integrated with the combinable media, and display the modified media file and the combinable media.

5. The system of claim 1, further comprising:
a queue that is configured to manage an order in which a plurality of user media files is integrated with the combinable media and an amount of time for which a specific one of the plurality of user media files remains integrated with the combinable media.

6. The system of claim 1, wherein the processing of the input is done in real time and is based on at least one from among the user's input, a user friend's input, and an advertiser's input.

7. (canceled)

8. The system of claim 1,
wherein the display is part of at least one from a group of Out of Home (OOH) advertising devices comprising a billboard, a transit vehicle, a street furniture, an arena, a fuel station, a dining establishment, a social establishment, a retail establishment, a health club, an educational campus, a shopping center, a public space, a computer screen, a smart phone display, a tablet display, an audience display, a cinema, a television, a concert, and
wherein the combinable media is an advertisement that is at least one from a group comprising a digital image, a video, an audio file, an online advertisement, a TV broadcast commercial, and a mobile application advertisement.

9. A user device configured to provide interactive multimedia placement, the user device comprising:
a display configured to display a user interface and receive a request from a user;
a controller configured to process the request by identifying a media file and a combinable media, and modify the media file such that a modified media file is configured to be integrated with the combinable media; and
a transmitter configured to transmit the modified media file and the combinable media,
wherein transmitting the modified media file and the combinable media is based on at least one of a proximity of the user device to the display, an amount paid by a user through the user device, a quality value of a task completed by the user through the user device, a count value of a total number of a plurality of tasks completed by the user through the user device, a priority of the user, and a rank of the modified media file and the combinable media determined by other users.

10. The user device of claim 9, further comprising:
a queue that is configured to manage an order in which a plurality of user media files is integrated with the combinable media and an amount of time for which a specific one of the plurality of user media files remains integrated with the combinable media.

11. The user device of claim 9, wherein the processing of the input is done in real time and is based on at least one from among the user's input, a user friend's input, and an advertiser's input.

12. (canceled)

13. A display device configured to display a media file and a combinable media, the display device comprising:
a receiver configured to receive a request from a user;
a controller configured to process the request by identifying a media file and the combinable media, modify the media file such that a modified media file is configured to be integrated with the combinable media; and
a display configured to display the modified media file and the combinable media,
wherein the display device displays the modified media file and the combinable media based on at least one from among a proximity of a user device to the display, an amount paid by a user through the user device, a quality value of a task completed by the user through the user device, a count value of a total number of a plurality of tasks completed by the user through the user device, a priority of the user, and a rank of the modified media file and the combinable media determined by other users.

14. The display device of claim 13, further comprising:
a queue that is configured to manage an order in which a plurality of user media files is integrated with the combinable media and an amount of time for which the plurality of user media remains integrated with the combinable media.

15. The display device of claim 13, wherein the processing of the input is done in real time and is based on at least one from among the user's input, a user friend's input, and an advertiser's input.

16. (canceled)

17. A method for providing interactive multimedia placement, the method comprising:
receiving, from a user device, a media file;
modifying the media file such that a modified media file is configured to be integrated into a combinable media; and
displaying, on a media display, the modified media file and the combinable media,
wherein the displaying the modified media file and the combinable media is based on at least one of a proximity of the user device to the media display, an amount paid by a user through the user device, a quality value of a task completed by the user through the user device, a count value of a total number of a plurality of tasks completed by the user through the user device, a priority of the user, and a rank of the modified media file and the combinable media determined by other users.

18. The method of claim 17, further comprising: integrating the modified media file into the combinable media.

19. The method of claim 17, wherein the modifying and displaying is performed in real time and is based on at least one from among the user's input, a user friend's input, and an advertiser's input.

20. (canceled)

21. The method of claim 17, further comprising:
receiving, from the user device, a request for the media file;
wherein modifying the media file further comprises: splicing the modified media file into the combinable media in real time; and
wherein displaying the modified media file and the combinable media further comprises: displaying, on the media display, the combinable media with the spliced in modified media file.

22. The method of claim 21, wherein the displaying is based on at least one from among a proximity of the user device to the display, an amount paid by a user through the user device, a quality value of a task completed by the user through the user device, a count value of a total number of a plurality of tasks completed by the user through the user device, a priority of the user, and a rank of the media file and the combinable media determined by other users.
